(19) United States
(12) Patent Application Publication
(10) Pub. No.: US 2008/0303649 A1
(43) Pub. Date: Dec. 11, 2008

(54) METHOD FOR IMPROVING TRAFFIC SAFETY BY MEANS OF USING BEACONS

(75) Inventors: Guillermo Cajigas Bringas, Madrid (ES); Jose Carlos Sendra Alcina, Alcobendas (ES); Miguel Angel Touset Rios, Madrid (ES)

Correspondence Address: MERCHANT & GOULD PC, P.O. BOX 2903, MINNEAPOLIS, MN, 55402-0903, US

(73) Assignee: VODAFONE GROUP PLC, Newbury (GB)

(21) Appl. No.: 12/027,676

(22) Filed: Feb. 7, 2008

Related U.S. Application Data
(63) Continuation-in-part of application No. 11/964,317, filed on Dec. 26, 2007.

(30) Foreign Application Priority Data
Dec. 28, 2006 (ES) 200603302

(51) Int. Cl. B60Q 1/00

(52) U.S. Cl. 340/435; 340/425.5

(57) ABSTRACT

The invention relates to a method for improving traffic safety by means of using beacons, using for each vehicle (3) participating in the accident prevention TAP service means (1) of determining the speed of the vehicle and a terminal TE (2) connected to said means (1) and with access to a wireless access network (4). It further uses positioning beacons (6) located at different points of the road network (8), communicating through radio with the vehicles circulating close to them. By knowing the position of the vehicle (3) when it passes close to a beacon (6), the network (4) warns the terminal TE (2) of the safety parameters (maximum speed allowed, safety distance with the vehicle in front of it) at the point of the road network (8) in which the vehicle (3) circulates. The terminal (2) warns driver of said safety parameters so that he or she can take the appropriate actions.

This application is a Continuation-in-Part of application Ser. No. 11/964,317, filed 26 Dec. 2007, and which application(s) are incorporated herein by reference.

### FIELD OF THE INVENTION

The present invention relates to a method for preventing traffic accidents using a terminal with access to the mobile telephony network. By knowing the position of the vehicle by means of using beacons located at different points of the road network, the network warns the terminal of the safety parameters (maximum speed allowed, safety distance to the vehicle in front of it) at the point of the road network in which the vehicle is circulating. The terminal warns the driver of said safety parameters so that he or she can take the appropriate actions.

### BACKGROUND OF THE INVENTION

Today the safety of vehicles circulating on the road is based on the drivers observing road signs as well as the recommendations provided by the competent organization through lighted panels situated on the road. In recent studies, it has been determined that speeding is one of the most common causes of traffic accidents and that an average speed reduction of 1 Km/h could reduce the total number of accidents by 3%. For this purpose, initiatives such as that of the driver's license point system are being carried out in different countries.

The present invention consists of a method for preventing traffic accidents by means of informing drivers of dynamic up-to-date information regarding safety on the road (speed limit, safety distance) according to climate considerations, congestion level of the road or blind spots where it is necessary to take maximum precautions. The solution can be integrated as an added value to commercial GPS navigation systems.

### SUMMARY OF THE INVENTION

The present invention relates to a method for preventing traffic accidents according to claim 1 and claim 7, in its two alternative solutions. Preferred embodiments of said methods are defined in the dependent claims.

In both solutions each vehicle circulating on the road network and participating in the Traffic Accident Prevention by Beacons TAPB service that said method provides has a terminal TE (for example, a mobile telephone with an installed application) that can access a wireless access network (for example, a mobile telephony network). The method in both alternative solutions has positioning beacons located at different points of the road network, which beacons transmit by radio their identifier ID_{B} and the TAPB service identifier ID_{TAPB} they provide.

The method described in claim 1 comprises the following steps for each vehicle participating in the TAPB service:

First of all, it is necessary to subscribe to the TAPB service. For that purpose the terminal TE of the vehicle sends a request to the wireless access network to subscribe to said TAPB service, sending the following data with said request: the TAPB service identifier being requested, and optionally the number of points that the driver of the vehicle has in the event that the country in which the vehicle is located uses a driver's license point system. The wireless access network checks the subscription validation of the terminal TE, storing data received in the previous request and optionally confirming to the terminal TE its subscription to the TAPB service.

Subsequently, the wireless access network sends the terminal TE a temporary identifier ID_{TE} of the terminal TE and optionally an update of the number of points the driver of the vehicle has and generic safety parameters SP_{RNs} that the vehicle must observe at the point of the road network in which the vehicle is currently located (for example, in the event that its position can be estimated by the cell identifier “cell-id” in which the terminal TE is located, in the event that it is a mobile telephone, for example). Once this data is received, the terminal TE is placed in listen mode to receive information from the positioning beacons in the communication channel used by said beacons to communicate with the vehicles using the TAPB service. Once a message broadcast by a positioning beacon has been received, the terminal TE checks that the service provided by said beacon corresponds with the TAPB service, in which case the terminal TE sends to the wireless access network the identifier ID_{B} of the beacon, its identifier ID_{TE}, and optionally safety parameters SP_{MEAs} (such as for example the speed of the vehicle obtained by the means of determining the speed of the vehicle) of the vehicle measured therein. In the event that the terminal TE does not send said safety parameters SP_{MEAs}, the wireless access network calculates the safety parameters SP_{MEAs} of the vehicle from the register times of the different data sent by the terminal TE to the wireless access network.

The wireless access network then optionally stores the data received, and sends to the terminal TE safety parameters SP_{RNs} that the vehicle must observe at the point of the road network in which the vehicle is currently located (such as for example the speed allowed for said vehicle at the point of the road network in which it is located), and optionally an update of the number of points. The terminal TE communicates the current SP_{RNs} to at least one of the occupants of the vehicle, normally to the driver of the vehicle, and/or to an external system in charge of automatically adjusting the speed of the vehicle. In the event that SP_{MEA}>SP_{RN}, for any of the safety parameters that are considered, the terminal TE warns of said situation so that the vehicle observes the SP_{RNs}.

The vehicle circulating in the road network and subscribed to the Traffic Accident Prevention by Beacons TAPB service provided by said method can additionally have means of determining the speed of the vehicle, connected to a terminal TE, the latter having access to the information provided by said means.

The safety parameters SP_{MEAs} will normally be the speed of the vehicle, either measured by the vehicle itself through the means of determining the speed of the vehicle, or calculated by the wireless access network. The safety parameters SP_{RN} will in this case be the speed allowed for said vehicle at the point of the road network in which it is located.

The vehicle subscribed to the TAPB service can in turn have means of detecting the distance D_{S} to the vehicle in front of it. In this case, the safety parameters SP_{MEAs} would be the speed of the vehicle and the distance D_{S}, whereas the safety parameters SP_{RNs} would be the speed allowed for said vehicle at the point of the road network in which it is located and the safety distance that it must maintain with the vehicle in front of it at said point of the road.

When the safety parameters SP_{MEAs} of the vehicle are measured therein and in the event that SP_{MEA}>SP_{RN} is met in a predetermined number of times, the terminal TE sends a message to the wireless access network to communicate the violation of the established safety parameters. However, when the safety parameters SP_{MEAs} of the vehicle are calculated by the network and in the event that SP_{MEA}>SP_{RN} is met in a predetermined number of times, the wireless access network will send a message to the terminal TE to communicate the violation of the established safety parameters and/or a fine for the violation committed.

### BRIEF DESCRIPTION OF THE DRAWINGS

To better understand the invention, an embodiment of the invention will be briefly described below as a non-limiting and illustrative example thereof. To that end, reference is made to the attached drawings, in which:

FIG. 1 shows the interaction of the terminal TE, connected to means of determining the speed of the vehicle, with the wireless access network.

FIG. 2 shows an alternative solution in which the vehicle does not have means of determining the speed.

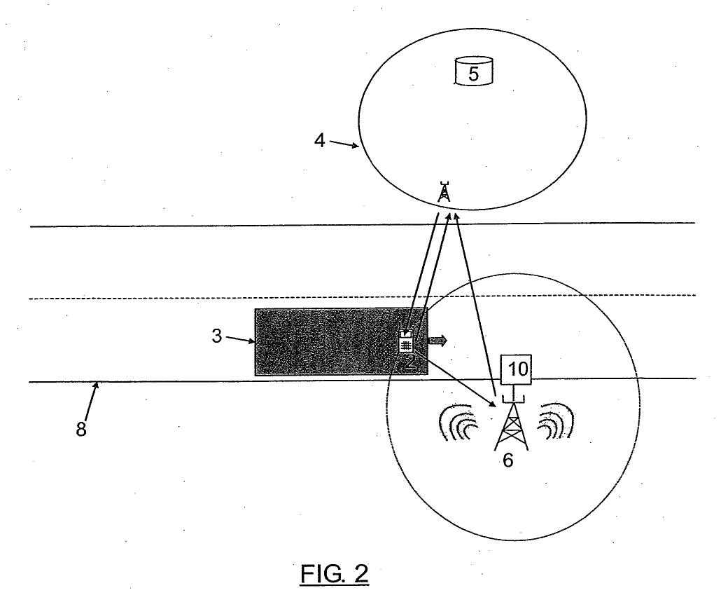

### DETAILED DESCRIPTION OF THE PREFERRED EMBODIMENT(S)

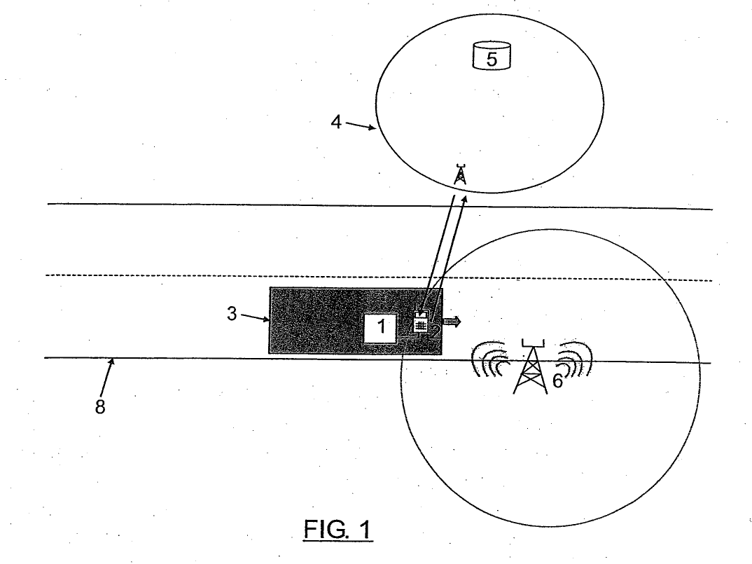

As shown in FIG. 1, a preferred embodiment of the method object of the invention is based on the availability of means 1 of determining the speed of the vehicle (a speedometer, for example) connected to a terminal TE 2, such as for example a mobile telephone of the driver of vehicle 3, which the terminal TE 2 has a client application installed and has access to the information provided by said means 1. The method uses positioning beacons 6 located on the roads and/or mobile beacons 6 (the latter normally being equipped with means of determining their position) using any type of wireless technology, normally short-range technology such as RFID. The beacons 6 emit in their environment in broadcast mode, or they can be activated by means of a presence sensor of the vehicle so they are not always emitting, their identifier ID_{B} and the service identifier ID_{TAPB} that they provide. The manner of implementing it is the following:

Terminal TE 2 subscribes to the service. To that end, it sends a request to a wireless access network 4 responsible for managing the traffic accident prevention TAPB service, as is done for example in the presence service defined by 3GPP for UMTS networks, although the solution would not be restricted to this type of networks. The parameters that are included in the request are: the service identifier, which will be called TAPB (Traffic Accident Prevention by Beacons) and optionally the number of points that the driver of the vehicle has (if the country in which the vehicle is located has a driver's license point system).

In response to this request, the wireless access network 4 will optionally store the previous data in a database 5 and/or check the subscription validation of the terminal TE, confirm its subscription to the TAPB service and send:

associated to the subscription, an identifier ID_{TE} thereof to TE 2;

optionally, an update in the number of points if that number sent by TE 2 is greater than the number registered in the network or if the user has been able to recover points.

TE 2 will be placed in listen mode such that it will be dedicated to listening to the information emitted by the beacons 6. In the event that the beacon 6 transmits through RFID, the terminal TE 2 will listen in the frequency referred for this service.

TE 2 measures its current safety parameters SP_{MEAs} (normally speed and safety distance) and for example registers its maximum values in a time period to be configured. This process can be carried out continuously or periodically. In this case, speed should be measured by an external sensor (e.g. the speedometer 1 of the vehicle itself).

Upon listening to the message broadcast by a beacon 6, TE 2 checks the service identifier it provides. If it coincides with that of the TAPB prevention service, ID_{TAPB}, TE 2 will send to the network 4 its identifier ID_{TE}, the identifier ID_{B} of the beacon, and optionally the last measurement of its safety parameters SP_{MEAs} (the current and maximum speed and safety distance, measured for example by means of a proximity sensor located at the front part of the vehicle, in a certain time period). If there were several nearby beacons 6 broadcasting, the one with the most power received would always be used and is usually the one closest to the vehicle. In any case, an attempt should be made to prevent this with a suitable planning of their locations, especially because it could provide erroneous data if there is another road very close by. If the beacon is mobile, such as the one located in a police car, it will be the priority beacon due to reception power or because the identifier ID_{B} it broadcasts indicates that it has a higher priority. Therefore, the ID_{B} can have a structure useful for giving priorities. The network 4 could also be made to temporarily disable or change the information associated to the fixed beacons 6 close to the mobile beacon of the police with the information of the latter. To determine the circulating direction of the vehicle, the terminal TE 2 can store the identifiers ID_{B} of the beacons 6. The ID_{B} of the previous beacon 6 stored in the terminal TE 2 will be used to determine its circulating direction. Another simpler option is that TE 2 sends to the network 4 a list of the beacons 6 it detects and the network 4 with the ID_{B} of the previous beacon or beacons stored in its database 5 will determine the circulating direction and, together with information of a map, provide TE 2 with the safety parameters SP_{RNs} that the vehicle 3 must observes at the point of the road network 8 in which it is currently located. In this case, the network 4 will fill the database 5 with the ID_{B} of the beacon 6 chosen by it.

Then the network 4 optionally stores the information received in the database 5 and includes it, for example, in a table with columns (ID_{B}, current speed) as information for later use, as it indicates to the network 4 the congestion condition of the road at the point in which the beacon is located. The network 4 calculates the safety parameters SP_{RNs} for this vehicle 3 according to the points it provided when it subscribed to the service and will send them to TE 2.

The TE 2 shows the received SP_{RNs} to the user. The proposed interface is a voice interface, for which a Text-Voice converter in TE 2 or the addition in the previous response of network 4 of an audio file such as “We inform you that on the road in which you are circulating, for your safety, a maximum speed of 80 Km/h must be observed and a safety distance of 60 meters with the vehicle in front of you must be maintained” will be required.

TE 2 will continue measuring its current safety parameters SP_{MEAs} (speed and safety distance) and will compare with them those previously indicated by the network 4 (SP_{RNs}). In the event that SP_{MEA}<SP_{RN}, nothing happens. If SP_{MEA}>SP_{RN} (for example, if the maximum speed for the driver's license points it has is exceeded), TE 2 will warn the driver by means of a voice interface, for example. If the values are exceeded after a certain number of times (consecutive or not, in accordance with what is determined), a message can be sent to the network 4 to subsequently fine the driver, for example, and a warning that the driver has been fined is sent to him or her.

If the network 4 detects that TE 2 is inactive for a time to be defined, TE 2 must subscribe again (thus, the number of driver's license points is always up-to-date).

There is another alternative method for traffic accident prevention by beacons 6, as claimed in claim 7. As in the method described until now, a terminal TE 2 with access to the wireless access network 4 is needed. But in this case it is not necessary for the vehicle 3 to have means 1 of determining the speed of the vehicle 3. The TAPB service has positioning beacons 6 located at different points of the road network 8, preferably provided with means 10 of determining the speed of the vehicles 3 passing through the points of the road network 8 in which said beacons 6 are located, said beacons 6 transmitting by radio their identifier ID_{B}, the TAPB service identifier ID_{TAPB} that they provide and optionally a time mark if the beacons have a common time base.

This method comprises the following steps for each vehicle 3 participating in the TAPB service:

Terminal TE 2 of the vehicle 3 sends a request to the wireless access network 4 to subscribe to the TAPB service, sending with said request the TAPB service identifier being requested and optionally the number of points that the driver of the vehicle 3 has in the event that the country in which the vehicle 3 is located uses a driver's license point system.

The wireless access network 4 optionally checks the subscription validation of the terminal TE 2.

The wireless access network 4 sends to the terminal TE 2 a temporary identifier ID_{TE} of the terminal TE and optionally an update of the number of points that the driver of the vehicle 3 has.

Terminal TE 2 is placed in listen mode, to receive information from the positioning beacons 6, in the communication channel used by said beacons 6 to communicate with the vehicles 3 using the TAPB service.

Once a message broadcast by a positioning beacon 6 has been received, the terminal TE 2 checks that the service provided by said beacon 6 corresponds to the TAPB service, in which case the terminal TE 2 sends to the positioning beacon 6 its identifier ID_{TE}, and optionally the identifier ID_{B} of the previous beacon (useful for obtaining the circulating direction of the vehicle 3) and, if the beacons have a common time base, the time mark of the previous beacon 6 (to calculate the average speed of the vehicle 3) with which the vehicle 3 has communicated, in the event that the terminal TE 2 stores the identifiers ID_{B} and the time marks of the beacons 6 through which it passes. TE 2 would further store the ID_{B} of the current beacon 6 and the time mark it has listened to for the purpose of sending it to the next beacon when it listens to its broadcasting message.

The beacon verifies the identifier ID_{B} of its predecessor (the previous beacon anterior through which the vehicle has passed) and if it is correct, it will then process the message sent by TE 2, otherwise it will discard it. This is useful for eliminating the problems of a TE 2 being able to listen to several beacons. In the case that it is correct, there are two possibilities:
1. The beacon measures safety parameters SP_{MEAs} of the vehicle (speed and safety distance, for example) with the available equipment (e.g. a radar) or with optional values of the time marks between two consecutive beacons, if the beacons have a common time base and the beacons know the distance between them. The time mark of the current beacon is known by the beacon itself because it coincides with that of the last broadcasting message it has sent; and the time mark of the previous beacon is that sent by TE 2. The beacon 6 sends to the wireless access network 4 the identifier ID_{TE}, its identifier ID_{B} and optionally said SP_{MEAs}.
2. If the beacons cannot calculate the SP_{MEAs} or in the event that the beacon 6 does not send said safety parameters SP_{MEAs}, the wireless access network 4 calculates the safety parameters SP_{MEAs} of the vehicle 3 based on the register times of the different data sent by the beacon 6 to the network 4. The beacons would then be limited to sending ID_{TE} and ID_{B} to the network 4 and such network returns to the user the SP_{RNs} for the user and would itself calculate the (average) speed based on the current speed and on a previous register in the database. The network 4, through its register database 5, will know the entry time therein of a previous value (ID_{B} of the previous beacon). With the register times in the database 5 of the ID_{B} of the current beacon and the ID_{B} of the previous beacon through which the vehicle has passed, and knowing the position of the beacons, the network 4 can estimate the circulating speed of the vehicle 3.

The wireless access network 4 sends to the terminal TE 2 safety parameters SP_{RNs} that the vehicle 3 must observe at the point of the road network 8 in which it is currently located and optionally an update of the number of points.

The terminal TE 2 communicates the current SP_{RNs} to at least one of the following, to at least one of the occupants of the vehicle 3 and/or to an external system responsible for controlling the speed of the vehicle.

In the event that the wireless access network 4 detects that SP_{MEA}>SP_{RN} for any of the safety parameters that are considered, the network 4 warns the terminal TE 2 of said situation so that the vehicle observes the SP_{RNs}. In the event that SP_{MEA}>SP_{RN} is met in a predetermined number of times, the wireless access network 4 can send a message to the terminal TE 2 to communicate the violation of the established safety parameters and/or a fine for the violation committed.

The beacon 6 can have means of detecting the distance D_{S} between the vehicle 3 and the vehicle in front of it, in which case SP_{MEAs} are the speed of the vehicle 3 and the distance D_{S}, whereas SP_{RNs} is the speed allowed for said vehicle 3 at the point of the road network 8 in which it is located and the safety distance that it must maintain with the vehicle in front of it at said point of the road 8. Therefore, as in the first claimed method, the safety parameters can be the maximum speed and/or the safety distance.

In the event that TE 2 remains inactive for a time to be defined, TE 2 must subscribe again.

1. A method for improving traffic safety by means of using beacons, wherein each vehicle circulating in the road network and subscribed to a traffic accident prevention by beacons service, TAPB service, provided by said method has a terminal TE which can access a wireless access network managing the service, wherein said TAPB service has positioning beacons located at different points of the road network transmitting by radio their identifier ID_{B} and the TAPB service identifier ID_{TAPB} that they provide, and in that said method comprises the following steps for each vehicle participating in the TAPB service;
a) the terminal TE of the vehicle sends a request to the wireless access network to subscribe to the TAPB service, sending the following data with said request:
the TAPB service identifier being requested;
and optionally:
the number of points that the driver of the vehicle has in the event that the country in which the vehicle is located uses a driver's license point system;
b) the wireless access network optionally checks the subscription validation of the terminal TE;
c) the wireless access network sends to the terminal TE:
a temporary identifier ID_{TE} of the terminal TE; and optionally
an update of the number of points that the driver of the vehicle has;
d) the terminal TE is placed in listen mode, to receive information from the positioning beacons in the communication channel used by said beacons to communicate with the vehicles using the TAPB service;
e) once a message broadcast by a positioning beacon has been received, the terminal TE checks that the service provided by said beacon corresponds with the TAPB service, in which case the terminal TE sends to the wireless access network:
the identifier ID_{B} of the beacon,
its identifier ID_{TE}, and optionally
safety parameters SP_{MEAs} of the vehicle measured therein; in the event that the terminal TE does not send said safety parameters SP_{MEAs}, the network calculates the safety parameters SP_{MEAs} of the vehicle based on the register times of the different data sent by the terminal TE to the network;
f) the wireless access network sends to the terminal TE safety parameters SP_{RNs} that the vehicle must observe at the point of the road network in which it is currently located and optionally an update of the number of points;
g) the terminal TE communicates the current SP_{RNs} to at least one of the following:
to at least one of the occupants of the vehicle,
to an external system;
h) in the event that SP_{MEA}>SP_{RN} for any of the safety parameters that are considered, the terminal TE warns of said situation so that the vehicle observes the SP_{RNs}.

2. A method according to claim 1, wherein each vehicle circulating in the road network and subscribed to the, TAPB service provided by said method additionally has means of determining the speed of the vehicle connected to a terminal TE, the latter having access to the information provided by said means.

3. A method according to claim 1, wherein SP_{MEA} is the speed of the vehicle, whereas SP_{RN} is the speed allowed for said vehicle at the point of the road network in which it is located.

4. A method according to claim 1, wherein the vehicle subscribed to the TAPB service has means of detecting the distance D_{S} to the vehicle in front of it, characterized in that SP_{MEAs} are the speed of the vehicle and the distance D_{S}, whereas SP_{RNs} is the speed allowed for said vehicle at the point of the road network in which it is located and the safety distance that it must maintain with the vehicle in front of it at said point of the road.

5. A method according to claim 1, wherein the safety parameters SP_{MEAs} of the vehicle are measured therein, characterized in that in the event that SP_{MEA}>SP_{RN} is met in a predetermined number of times, the terminal TE sends a message to the wireless access network to communicate the violation of the established safety parameters.

6. A method according to any of claims 1, wherein the safety parameters SP_{MEAs} of the vehicle are calculated by the network, wherein in the event that SP_{MEA}>SP_{RN} is met in a predetermined number of times, the wireless access network sends a message to the terminal TE to communicate the violation of the established safety parameters and/or a fine for the violation committed.

7. A method for improving traffic safety by means of using beacons, wherein each vehicle circulating in the road network and subscribed to a traffic accident prevention by beacons service TAPB service, provided by said method has a terminal TE which can access a wireless access network managing the service, wherein said TAPB service has positioning beacons located at different points of the road network, said beacons transmitting by radio their identifier ID_{B} and the TAPB service identifier ID_{TAPB} that they provide and optionally a time mark, and in that said method comprises the following steps for each vehicle participating in the TAPB service:
a) the terminal TE of the vehicle sends a request to the wireless access network to subscribe to the TAPB service, sending the following data with said request:
the TAPB service identifier being requested;
and optionally:
the number of points that the driver of the vehicle has in the event that the country in which the vehicle is located uses a driver's license point system;
b) the wireless access network optionally checks the subscription validation of the terminal TE;
c) the wireless access network sends to the terminal TE:
a temporary identifier ID_{TE} of the terminal TE; and optionally
an update of the number of points that the driver of the vehicle has;
d) the terminal TE is placed in listen mode to receive information from the positioning beacons, in the communication channel used by said beacons to communicate with the vehicles using the TAPB service;
e) once a message broadcast by a positioning beacon has been received, the terminal TE checks that the service provided by said beacon corresponds with the TAPB service, in which case the terminal TE sends to the positioning beacon:
its identifier ID_{TE}, and optionally
the identifier ID_{B} and the time mark of the previous beacon with which the vehicle has communicated in the event that the terminal TE stores the identifiers ID_{B} and the time marks of the beacons through which it passes;
f) the beacon through which the vehicle passes sends to the wireless access network the identifier ID_{TE} and its identifier ID_{B} and optionally safety parameters SP_{MEAs} in the event that the beacon measures them; in the event that the beacon does not send said safety parameters SP_{MEAs}, the network calculates the safety parameters SP_{MEAs} of the vehicle based on the register times of the different data sent by the beacon to the network;
g) the wireless access network sends to the terminal TE safety parameters SP_{RNs} that the vehicle must observe at the point of the road network in which it is currently located and optionally an update of the number of points;
h) the terminal TE communicates the current SP_{RNs} to at least one of the following:
to at least one of the occupants of the vehicle,
to an external system;
i) in the event that the wireless access network detects that SP_{MEA}>SP_{RN} for any of the safety parameters that are considered, the network warns the terminal TE of said situation.

8. A method according to claim 7, wherein the positioning beacons have means of determining the speed of the vehicles passing through the points of the road network in which said beacons are located.

9. A method according to claim 7, wherein SP_{MEA} is the speed of the vehicle, whereas SP_{RN} is the speed allowed for said vehicle at the point of the road network in which it is located.

10. A method according to claim 7, wherein the beacon has means of detecting the distance D_{S} between the vehicle and the vehicle in front of it, characterized in that SP_{MEAs} are the speed of the vehicle and the distance D_{S}, whereas SP_{RNs} is the speed allowed for said vehicle at the point of the road network in which it is located and the safety distance that it must maintain with the vehicle in front of it at said point of the road.

11. A method according to claim 7, wherein in the event that SP_{MEA}>SP_{RN} is met in a predetermined number of times, the wireless access network sends a message to the terminal TE to communicate the violation of the established safety parameters and/or a fine for the violation committed.
